(19) United States
(12) Patent Application Publication
(10) Pub. No.: US 2024/0045665 A1
(43) Pub. Date: Feb. 8, 2024

(54) MANUFACTURING USING CLOUD-CONTROLLED DEVICE CONFIGURATION AND TESTS

(71) Applicant: NEBULON, Inc., Fremont, CA (US)

(72) Inventors: SIAMAK NAZARI, Mountain View, CA (US); JOHN DICKINSON, San Jose, CA (US); SHAYAN ASKARIAN NAMAGHI, San Jose, CA (US)

(21) Appl. No.: 18/269,232

(22) PCT Filed: Dec. 22, 2021
(86) PCT No.: PCT/US21/64943

§ 371 Date: Jun. 22, 2023

Related U.S. Application Data
(60) Provisional application No. 63/129,468, filed on Dec. 22, 2020.
(60) Provisional application No. 63/132,067, filed on Dec. 30, 2020.

(51) Int. Cl. G06F 8/65; G06F 8/61; G06F 8/71; G06F 11/36

(52) U.S. Cl. CPC G06F 8/65; G06F 8/61; G06F 8/71; G06F 11/3696

(57) ABSTRACT

A manufacturer (120) of a device (140) uses a tester image (134) from a cloud service (130) when configuring test equipment (150) for testing of a device (140) being manufactured, and the device (140) contacts the cloud service (130) and installs firmware or software (146) based on a device image (132). A vendor or developer (110) can change or update the images (132, 134) to update a manufacturing process without needing the manufacturer (120) to have special training or knowledge. Further, the cloud service (130) can receive test results from the manufacturer (120) and may record access to image (132), enabling the vendor (110) to monitor manufacturing of the device (140).

### BACKGROUND

Product development commonly involves a vendor that designs, engineers, or sells a product and a contract manufacturer (CM) that manufactures the product. In such situations, the vendor would often like or need to control or define aspects of the manufacturing process. For a complex electronic device, for example, the contract manufacturer manufacturing the device generally needs to assemble the device, install software or firmware on the device, and test the device. The vendor may provide the software or firmware to the contract manufacturer and may want to update the software or firmware for a device while the contract manufacturer is manufacturing devices. Additionally, the vendor may want to change or update the device testing undertaken during manufacture, for example, to test updated firmware or software in the devices or to test for recently discovered device defects. Currently, changes that the vendor desires to make in software, firmware, or testing of a device may require the vendor to instruct or train the contract manufacturer to use the new software, firmware, or testing procedures. Such instruction or training can interrupt the manufacturing process.

### BRIEF DESCRIPTION OF THE DRAWINGS

FIG. 1 is a block diagram illustrating device manufacturing and testing system in accordance with an example of the present disclosure.

FIG. 2 is a flow diagram of a manufacturing process in accordance with an example of the present disclosure for manufacturing an electronic device.

The drawings illustrate examples for the purpose of explanation and are not of the invention itself. Use of the same reference symbols in different figures indicates similar or identical items.

### DETAILED DESCRIPTION

Product development and sales generally require design and engineering of a product and subsequently manufacture of the product for sale. Often, the design and engineering may take place at one location while manufacturing occurs elsewhere. For example, a vendor may design an electronic device in one country, while a contract manufacturer (CM) manufactures the product in another country. The manufacturer often needs software or firmware and test procedures that the vendor may develop and subsequently update. In accordance with an aspect of the current disclosure, systems and processes are provided that permit a vendor to: precisely define software, firmware, and test procedures; accurately impart the software, firmware, and test procedures to a remote manufacturer; and observe test results. Vendors may use the systems and methods disclosed herein not only to prepare a manufacturer to begin building a product but also to update the product or the testing of the product after production has begun. In accordance with a further aspect of the present disclosure, systems and methods disclosed herein may improve the control that a vendor has over remote manufacturing of products.

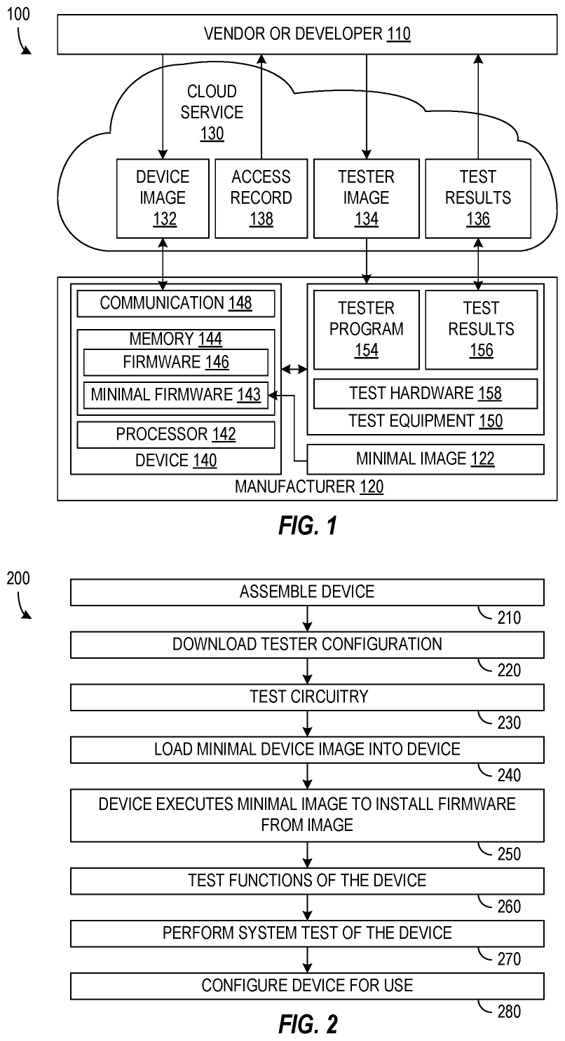

Manufacturing of a complex electronic device such as a storage device or server hardware may be a complex process requiring effective use of manufacturing and testing equipment. FIG. 1 illustrates a system 100 that uses cloud-based configuration of manufacturing and testing to improve remote manufacturing of an electronic device 140. Device 140 may be a complex device that includes a processor 142 with memory 144 for storing software or firmware that processor 142 can execute to perform the required functions of device 140. Device 140 further includes a communication interface 148, e.g., an Ethernet or Wi-Fi adapter, through which device 140 may communicate with remote devices, through networks. Device 140 may need communication interface 148 to implement the functions of device 140 or for possible updates of firmware in device 140 after the device is sold. In one example, device 140 may be an add-on card for a computer or server system, e.g., a Peripheral Component Interconnect Express (PCI-e) card, or printed circuit board with a connector or contacts that plug into a slot in a standard peripheral interface in host computer or server. In another example, device 140 is a storage or service processing unit such as described in International Publication No. WO 2021/174063, entitled “Cloud Defined Storage.” Device 140 could alternatively be a USB device or any type of device that has a network interface or may otherwise be connected to a system providing network communications to device 140.

In system 100, a vendor 110 works with a manufacturer 120. Vendor 110 may have designed or may be selling device 140, and manufacturer 120 may have contracted to manufacture devices 140, i.e., manufacturer 120 may be a contract manufacturer for vendor 110. In the example of FIG. 1, vendor 110 and manufacturer 120 are at different locations, e.g., different countries. For a manufacturing process that uses system 100, vendor 110 may provide hardware specifications to manufacturer 120 and may create a device image 132 and a tester image 134 that are accessible through a network, e.g., the Internet. Cloud service 130 may, for example, be implemented on a server owned or controlled by vendor 110, and the server may provide an interface for an authorized manufacturer 120 or authorized devices 140 to access device image 132 or tester image 134. In the example of FIG. 1, a cloud service 130 is accessible to vendor 110 and manufacturer 120, so that vendor 110 can upload device image 132 and tester image 134, and manufacturer 120 can download at least tester image 134. Device image 132 includes data or programming for installation of software or firmware 146 on device 140. Tester image 134 includes data or programming for operation of test equipment 150 that manufacturer 120 uses during manufacture of device 140.

FIG. 2 is a flow diagram of a manufacturing process 200 that uses system 100 during manufacture of device 140. Manufacturing process 200 may begin with an assembly process 210 in which manufacturer 120 assembles the components of device 140. Such assembly may include fabricating a printed circuit board (PCB) and attaching one or more integrated chips and other active circuit elements on the PCB to form all or a testable portion of device 140.

Manufacturer 120 in a tester configuration process 220 downloads tester image 134 from cloud service 130 and configures test equipment 150 that the manufacturer 120 uses during a configuration process 220. Tester image 134 may, for example, include a recipe for test procedures, and each test procedure may be described using a programming language that test equipment 150 can interpret. Manufacturer 120 may perform configuration process 220 to program test equipment 150 when initially setting up to manufacture a batch of devices 140 or in response to being informed of a change in tester image 134. Alternatively, test equipment 150 may check a version number of tester image 134 periodically or each time before testing of each device 140 and may perform tester configuration process 220 when tester image 132 has changed.

The assembled circuitry of device 140 may then be electrically tested in a test process 230. An in-circuit test (ICT) process, for example, may use an electrical test probe, e.g., a bed of nails tester, to test a populated printed circuit board. Test equipment 150 of manufacturer 120 may use the test probe to check for shorts or opens and measure basic electrical characteristics such as resistance, capacitance, and inductances at a point or between points in the circuit. The measurements may be compared to target or nominal values, e.g., value ranges extracted from tester image 134, to determine whether the device 140 was correctly assembled. Results from circuit test 230 may be added to test results 156 at manufacturer 120 and uploaded to test results 136 at cloud service 130, where vender 110 may access and use test results 136 as described further below. In some implementations, manufacturer 120 may be relieved from needing to locally store test results 156 at the facilities of manufacturer 120, and test results 136 are automatically stored at cloud service 130 and may be shared by vendor 110 and manufacturer 120.

Some programming or configuration of device 140 may be performed before or as part of device assembly 210 or circuitry testing 230. In some cases, minimal software or firmware 143 may be installed in one or more components of device 140 before or during the assembly process 110 or as part of circuitry test process 230. In the example of FIG. 2, manufacturer 120 performs an installation process 240 after circuit testing 230. Installation process 240 uses a minimal image 122, which may be kept at the facilities of manufacturer 120, to install minimal firmware/software 143 into device 140. Minimal firmware/software 143 does not need to implement all required functions of device 140 but only needs to enable device 140 to execute an installation process 250. For installation process 250, processor 142 executes minimal firmware 143 to operate communication interface 148, contact cloud service 130, download from the current device image 132 at cloud service 130, and use current device image 132 to install the latest version of software or firmware 146 into device 140.

Cloud service 130 may require authentication from minimal firmware 143 or from manufacturer 120 before permitting a download of device image 132. Cloud service 130 may also record information, e.g., an access record 138, regarding the download of device image 132, for example, to subsequently provide vendor 110 with an accounting of when or by whom device image 132 was used.

A function test process 260 in process 200 of FIG. 2 tests the functions device 140. Function tests 260 may be interleaved with software/firmware installations or updates 250 and typically include short-duration tests run to ensure no manufacturing issues prevent any of the required functions of device 140 from working. Tester program 154 may identify which or how functional tests 250 are performed and indicate criterion for passing a function test 260. Results from function tests 260 may be added to test results 156 at the manufacturer and uploaded to tests results 136 in cloud service 130.

A system test 270 may be a longer test of functionality of device 140, and manufacturer 120 runs system test 270 to ensure no manufacturing issues limit the ability of device 140 to continue operations. Again, tester program 154 may indicate how system test 270 is performed and indicate criteria for passing system test 270. Results from system test 270 may be added to test results 156 at manufacturer 120 and uploaded to tests results 136 in cloud service 130.

If device 140 passes system test 270, a final configuration process 280 may include specific product configuration (if any) of device 140 to put device 140 in a saleable state. Configuration process 280 may configure device 140 differently depending on a customer or stock keeping unit (SKU) intended for device 140. Again, device 140 may access device image 132 at cloud service 130 to download information for final configuration process 280. Alternatively, manufacturer 120 may download the final configuration information from cloud server 130.

Device manufacturing and testing system 100 of FIG. 1 and manufacturing process 200 of FIG. 2 allow vendor 110 to efficiently control, change, or update a manufacturing process. For example, if vendor 110 develops an update to firmware 146 for device 140, vendor 110 may update device image 132 according to the firmware update and may update tester image 134 if new test processes are needed to test device 140 after the update. The changes in the device image 132 and tester image 134 are largely transparent to manufacturer 120 and do not interrupt the manufacturing process. If vendor 110 becomes aware of a product defect, vendor 100 may update tester image 134 to automatically add or change test procedures and again the change in testing can be quickly implemented without interrupting manufacture of product, e.g., for training of manufacturer 120.

System 100 also allows vendor 110 to better monitor the manufacturing process. Vendor 110 may, for example, analyze test results 136 from cloud server 130 to detect problems or changes in the manufacturing process. Vender 110 may also analyze records 138 from cloud service 130 to monitor the number of devices that are being manufactured and ensure that devices are being manufactured in accordance with contracts or agreements with authorized manufacturer 120.

As described herein, firmware, software, and test programs or parameters, which were conventionally stored on-site at each manufacturing facility, may now be kept at a cloud service that a vendor controls. This avoids problems or difficulties for both the vendor designing the product and a contract manufacturer building the product. The vendor or contract manufacturer have less difficulty ensuring the right versions of software or firmware and test procedures are being used for a product even when firmware, software, and manufacturing tests often change. Also, a contract manufacturer does not need to have the expertise required to update the firmware, software, and tests and does not require time-consuming support from the vendor to update configuration or tests of products at the manufacturer's facilities. Finally, the cloud service allows automated storage of test results and sharing of test results with the vendor.

An additional benefit of cloud-based device configuration and testing is that a contract manufacturer may be required to log into the cloud service and every manufactured system or device must contact the cloud service to be updated to a functional state so that the vendor has visibility into all systems or devices being produced by the contract manufacturer. The vendor can thus detect when unauthorized or counterfeit devices are being manufactured.

All or portions of some of the above-described systems and methods can be implemented in a computer-readable media, e.g., a non-transient media, such as an optical or magnetic disk, a memory card, or other solid state storage containing instructions that a computing device can execute to perform specific processes that are described herein. Such media may further be or be contained in a server or other device connected to a network such as the Internet that provides for the downloading of data and executable instructions.

Although implementations have been disclosed herein, these implementations are only examples and should not be taken as limitations. Various adaptations and combinations of features of the implementations disclosed are within the scope of the following claims.

What is claimed is:

1. A process comprising:
a manufacturer manufacturing a device and installing a first program in the device;
operating the device to execute the first program to access a cloud service and install in the device a version of a second program from a current version of a first image that the cloud service provides; and
the manufacturer testing operation of the device while the device executes the second program.

2. The process of claim 1, wherein the first program is software or firmware that lacks one or more capabilities needed for the testing of the operation of the device.

3. The process of claim 2, wherein the second program is software or firmware of the device that makes the device functional for the testing of the operation of the device.

4. The process of claim 1, further comprising a developer of the device updating the first image that the cloud service provides so that the first image corresponds to an updated version of the second program.

5. The process of claim 1, further comprising a vendor monitoring downloads from the cloud service to detect unauthorized manufacture of devices.

6. The process of claim 1, further comprising:
the manufacturer accessing a current version of a second image at the cloud service; and
the manufacturer using the current version of the second image to configure test equipment for the testing of the operation of the device.

7. The process of claim 6, further comprising a developer of the device updating the current version of the first image and the current version of the second image to change the second program and the testing.

8. The process of claim 1, further comprising the manufacturer providing test results from the testing to the cloud service.

9. The process of claim 8, further comprising a vendor of the device analyzing the test results to monitor manufacturing of the device.

10. A process comprising:
a vendor providing a first image on a cloud service, the first image defining testing that a manufacturer needs to perform during manufacturing of a device;
the manufacturer configuring test equipment using the first image from the cloud service; and
the manufacturer assembling the device and testing the device using the test equipment configured using the first image.

11. The process of claim 10, further comprising the vendor updating the first image without informing the manufacturer.

12. The process of claim 10, further comprising:
the vendor providing a second image on the cloud service, the second image defining software or firmware of the device; and
the manufacturer operating the device, during manufacturing, so that the device contacts the cloud service and uses the second image to install the software or firmware of the device.

13. The process of claim 12, further comprising the vendor updating the first image and the second image without informing the manufacturer.
